(19) United States
(12) Patent Application Publication
(10) Pub. No.: US 2004/0148163 A1
(43) Pub. Date: Jul. 29, 2004

(54) System and method for utilizing an anchor to reduce memory requirements for speech recognition

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/348,943

(22) Filed: Jan. 23, 2003

(51) Int. Cl. G10L 15/00

(52) U.S. Cl. 704/231

(57) ABSTRACT

A speech recognition method includes receiving a sequence of acoustic observations. The method also includes detecting whether or not at least one of a set of prescribed patterns occurs in the sequence of acoustic observations. The method further includes, based on the detecting result, setting an anchor for each of the set of prescribed patterns detected, and splitting up the sequence of acoustic observations into separate subsequences separated by the anchor. The method also includes performing a speech recognition processing on each of the separate subsequences, in sequence, and joining that information along with information of the anchor, to obtain speech recognition processing of an entirely of the sequence of acoustic observations.

### FIELD OF THE INVENTION

The invention relates to a system and method for utilizing an anchor to reduce memory requirements for speech recognition.

### BACKGROUND OF THE INVENTION

In performing speech recognition processing, such as by way of a stack decoder process or by way of a frame synchronous beam search process, memory requirements for storing information of the speech recognition can be significant. This can be a problem when the speech recognizer does not have a large memory capacity,: such as for a Personal Digital Assistant (PDA) or for a third generation (3G) cell phone having speech recognition capabilities.

### SUMMARY OF THE INVENTION

According to one embodiment of the invention, there is provided a speech recognition method, which includes receiving a sequence of acoustic observations. The method also includes a step of determining whether or not at least one of a set of prescribed patterns occurs anywhere in the sequence of acoustic observations. The method further includes the step of, if the prescribed pattern is found, performing two separate speech recognitions, by splitting the original sequence of acoustic observations into a first subsequence of acoustic observations and a second subsequence of acoustic observations, based on the place in the original sequence of acoustic recognitions at which the prescribed pattern was found. One speech recognition is performed on the first subsequence of acoustic observations, and information related to speech recognition processing on the first acoustic observation is stored in a memory during the speech recognition processing. Another speech recognition is then performed on the second subsequence of acoustic observations, and information related to speech recognition processing on the second acoustic observation is stored in the memory. Based on the speech recognition of the first and second acoustic observations, and based on the prescribed pattern that was found, a complete speech recognition for the original sequence of acoustic observations is obtained.

According to another embodiment of the invention, there is provided a speech recognition system. The system includes an input unit configured to receive a sequence of acoustic observations. The system further includes a pattern detecting unit configured to detect whether or not at least one of a set of predetermined patterns occurs in the sequence of acoustic observations. The system still further includes an anchor setting unit configured to set an anchor for at least one of the set of prescribed patterns detected, and to split up the sequence of acoustic observations into separate portions separated by the anchor. The system also includes a speech recognition processing unit configured to perform speech recognition processing on each of the separate portions, and to join information obtained from each of the speech recognition processings, along with information of the anchor, to obtain speech recognition processing of an entirety of the sequence of acoustic observations.

According to yet another embodiment of the invention, there is provided a program product having machine-readable program code for performing speech recognition, the program code, when executed, causing a machine to perform the step of detecting whether or not at least one of a set of predetermined patterns occurs in a sequence of acoustic observations. The program code also causing the machine to perform the step of setting an anchor for at least one of the set of prescribed patterns detected by the first program product code, and splitting up the sequence of acoustic observations into separate subsequences separated by the anchor. The program code further causing the machine to perform the step of performing speech recognition processing on each of the separate subsequences, and joining information obtained from each of the speech recognition processings, along with information of the anchor, to obtain speech recognition processing of an entirety of the sequence of acoustic observations.

### BRIEF DESCRIPTION OF THE DRAWINGS

FIG. 1 is a flow chart showing speech recognition processing using an anchor, according to a first embodiment of the invention;

FIG. 2 shows an sequence of acoustic observations, with an anchor utilized to split the sequence of acoustic observations into a first and a second acoustic observation subsequence separated by the anchor, according to the first embodiment of the invention;

FIG. 3 shows an sequence of acoustic observations, with two separate anchors utilized to split the sequence of acoustic observations into a first, a second and a third acoustic observation subsequence separated by the anchors, according to a second embodiment of the invention;

FIG. 4 is a flow chart showing speech recognition processing using an anchor and showing the reuse of speech recognition memory, according to an embodiment of the invention; and

FIG. 5 is a flow chart match computation for spotting instances of a given sequence of speech elements using dynamic programmnmg.

### DETAILED DESCRIPTION OF THE INVENTION

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose.

As noted above, embodiments within the scope of the present invention include program products on computer-readable media and carriers for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program modules, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention is intended to be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The following terms may be used in the description of the invention and include new terms and terms that are given special meanings. “Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element.

Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are keep active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look-ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower, scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech/compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of speech elements subject to a grammar or to a statistical model for the probability of a particular speech element given the values of zero or more of the speech elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words are allowed to be the next word in the sequence. For each such word, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal word sequence.

“Pure statistical language model” is a statistical language model that has no grammatical component. In a pure statistical language model, generally every possible word sequence will have a non-zero probability.

“Entropy” is an information theoretic measure of the amount of information in a probability distribution or the associated random variables. It is generally given by the formula E=Σᵢ pᵢ log(pᵢ), where the logarithm is taken base 2 and the entropy is measured in bits.

“Perplexity” is a measure of the degree of branchiness of a grammar or language model, including the effect of non-uniform probability distributions. In some embodiments it is 2 raised to the power of the entropy. It is measured in units of active vocabulary size and in a simple grammar in which every word is legal in all contexts and the words are equally likely, the perplexity will be the vocabulary size. When the size of the active vocabulary varies, the perplexity is like a geometric mean rather than an arithmetic mean.

“Decision Tree Question” in a decision tree, is a partition of the set of possible input data to be classified. A binary question partitions the input data into a set and its complement. In a binary decision tree, each node is associated with a binary question.

“Classification Task” in a classification system is a partition of a set of target classes.

“Hash function” is a function that maps a set of objects into the range of integers {0, 1, . . . , N-1}. A hash function in some embodiments is designed to distribute the objects uniformly and apparently randomly across the designated range of integers. The set of objects is often the set of strings or sequences in a given alphabet.

“Lexical retrieval and prefiltering.” Lexical retrieval is a process of computing an estimate of which words, or other speech elements, in a vocabulary or list of such elements are likely to match the observations in a speech interval starting at a particular time. Lexical prefiltering comprises using the estimates from lexical retrieval to select a relatively small subset of the vocabulary as candidates for further analysis. Retrieval and prefiltering may also be applied to a set of sequences of speech elements, such as a set of phrases. Because it may be used as a fast means to evaluate and eliminate most of a large list of words, lexical retrieval and prefiltering is sometimes called “fast match” or “rapid match”.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

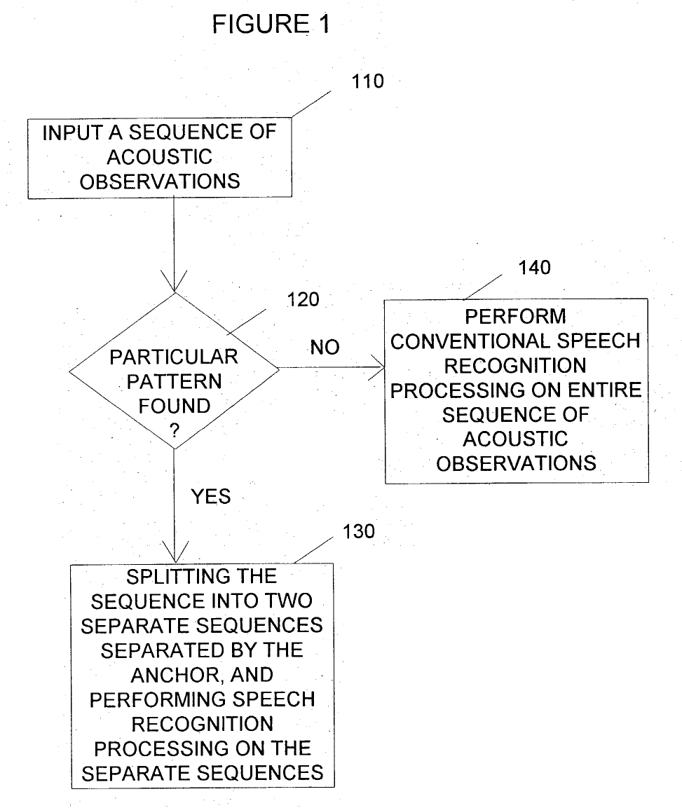

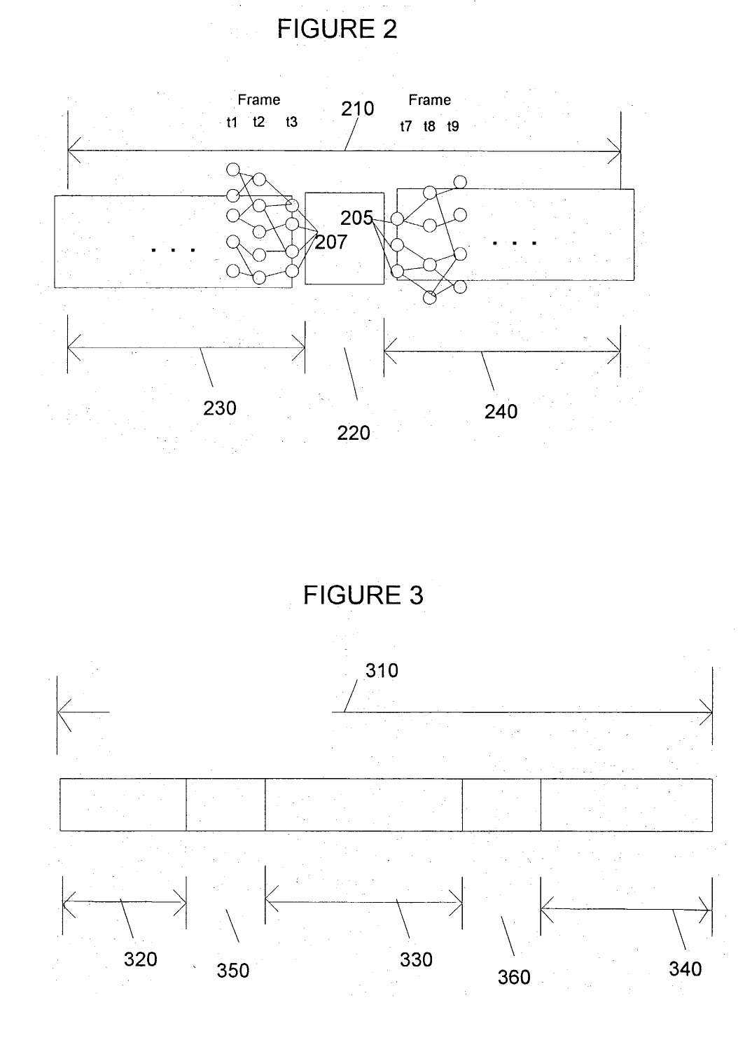

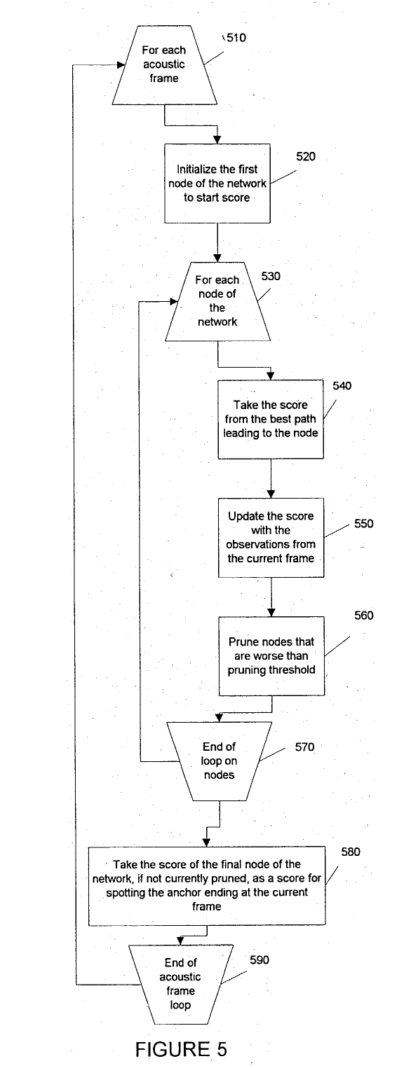

Referring now to FIG. 1 and FIG. 2, a first embodiment of the invention will be described below. The present invention recognizes an anchor, such as by word spotting or by phrase spotting, in a manner known to those skilled in the art. (An embodiment describing a word spotting computation according to at least one embodiment of the invention is shown in FIG. 5.) Preferably, the present invention targets only on very reliable anchors, such as long inter-phrase pauses or polysyllabic words, or canned phrases that occur only at a unique place in the grammar. When the anchor is found, this event is utilized to split the utterance into two smaller utterances, separated by the anchor. Each of the two smaller utterances are then recognized separately in a speech recognition process, thereby utilizing lesser memory resources than would be required if the entire utterance was to be recognized in a single speech recognition process.

Given that the anchor found is reliable, it is likely that any speech recognition process performed on the smaller utterances around the anchor will not be pruned in a speech recognition processing, even if the pruning bound is fairly tight. Also, the processing of each of the two smaller utterances is done irrespective of the processing of the other of the two utterances, thereby saving on system resources. At the end of the processing of the two smaller utterances, their speech recognition outputs are joined with the speech recognition output of the anchor, to provide a full speech recognition output for the entire utterance.

Referring now to FIG. 1, in a step 110, a sequence of acoustic observations are input. The sequence of acoustic observations may correspond, for example, to input speech, which has been processed in some way, such as by a phonetic recognizer, so that the sequence of acoustic observations corresponds to a phonetic lattice or a sequence of phonemes or a sequence of speech elements. As a further example, the sequence of acoustic observations may correspond to frequency characteristics of speech, as processed by a frequency characteristics analyzer.

In a step 120, it is determined whether a particular pattern in a set of particular patterns, is found in the sequence of acoustic observations. For example, if it is known beforehand that a speaker is speaking a phrase that includes a name of a state somewhere in the middle of the speaker's utterance, then in that case the set of particular patterns would correspond to the fifty (50) different state names, and any one of those state names being detected would correspond to the particular pattern being detected. It is preferable that the particular pattern being detected occur somewhere close to the middle of the acoustic observation sequence, in order to split the speech recognition process as evenly as possible. That way, each separate speech recognition processing to be performed on separate portions of the sequence of acoustic observations can be done within a limited memory space constraint.

If the determination in step 120 is that one pattern of the set of particular patterns is detected, such as by the detection of the word “California” in an input speech, then in step 130 that pattern is used as an anchor to split up the acoustic observation into a first acoustic observation subsequence and a second acoustic observation subsequence (separated from each other by the particular pattern that is detected). Two separate speech recognition processings are respectively performed on the first and second acoustic observation subsequences. If the determination in step 120 is that no pattern of the set of patterns is detected, then a conventional speech recognition process is performed in step 140 on the entire sequence of acoustic observations.

Referring now to FIG. 2, the particular pattern being detected in the sequence of acoustic observations 210 is represented by region 220. With that detection, then a first acoustic observation subsequence 230 is determined to start from a beginning point of the sequence of acoustic observations 210, to an ending point corresponding to a point just before the start of the region 220 corresponding to the particular pattern that was detected. Also, a second acoustic observation subsequence 240 is determined to start from a point just past the end of the region 220 corresponding to the particular pattern that was detected, to the end of the sequence of acoustic observations 210.

With the sequence of acoustic observations thereby split based on the anchor, two separate speech recognitions are performed—one on the first acoustic observation subsequence 230 and one on the second acoustic observation subsequence 240. The results of those two speech recognitions, which, in some embodiments, may be performed sequentially using the same memory space, are combined with the speech recognition results of the detected particular pattern, in order to obtain a speech recognition result of the entire sequence of acoustic observations 210. As such, a lesser memory capacity is achieved by way of the first embodiment of the invention, than would have been required if one or more speech recognition processes was performed on the entire sequence of acoustic observations 210, if achieved by way of the first embodiment of the invention.

In a second embodiment of the invention, a plurality of anchors may be used to split the sequence into more than two portions. For each pattern of the set of patterns found in the sequence of acoustic observations 210, the sequence of acoustic observations 210 is split about that anchor. Thus, for a case where two distinct patterns are found in a sequence of acoustic observations, the sequence of acoustic observations is split up into three separate, smaller acoustic observation subsequences, having two anchors defining the beginning and ending points of those three smaller acoustic observation subsequences. FIG. 3 shows such a sequence of acoustic observations 310, which is divided up into three separate smaller subsequences 320, 330, 340, separated from each other by the two distinct patterns 350, 360 that were detected.

The present invention is especially useful in cases where some knowledge of what the sequence of acoustic observations is known, such as knowledge that a speaker is speaking words that include digits somewhere in the middle portion of the speech. For example, if the speaker is speaking a phrase corresponding to a city, state, zip code, first name, and last name of a person, then such a phrase would include digits most likely only where the zip code portion of the speech occurs. With this as prior knowledge, a speech recognition process can look for digits in the input speech, and when they are found use that as the anchor for dividing up the input speech into a first portion having the city and state to be recognized (in a first speech recognition process using a memory space), and into a second portion having the first name and last name to be recognized (in a second speech recognition process that is performed after the first speech recognition process has completed, and which may use the same memory space).

As discussed above, the anchor may be a sequence of digits, a particular polysyllabic string, or it may be a pause of at least a particular length. For example, when a speaker speaks a city, state and zip code, there typically is a long pause between the speaking of the state name and the zip code. Thus, in a spoken sentence that includes this information along with other information, a detection of a long pause may likely correspond to a demarcation point between the state name and the zip code. Using this information, a first speech recognition process can proceed on a first portion of the input speech which ends at the point where the long pause was detected. In one example, a first hypothesis for the node directly preceding the anchor, working backwards, will correspond to all possible state names, since that is the likely first word (working backwords) that occurred before the long pause in the input speech. The speech recognition then will continue backwards, node by node, until the first portion of the input speech has been entirely processed and recognized.

Then, the second portion of the input speech is processed, by starting at the ending point of the long pause, and hypothesizing that the first word in the second portion of the input speech is a sequence of numbers corresponding to a legal zip code, and then continuing a speech recognition process until the end of the input speech is reached.

Thus, in the present invention, by knowing the particular pattern detected and the limited number of possibilities for the nodes that may occur before and after the occurrence of the particular pattern, the searches performed on the different, split portions of the sequence of acoustic observations can be done in a fast and accurate manner. FIG. 2 shows a speech recognition process whereby the starting point for the first acoustic observation subsequence 230, which corresponds to the ending point in time of that acoustic observation subsequence, is one of only a finite set of possible nodes (shown as four nodes 207 in that figure), and whereby the starting point for the second acoustic observation subsequence 240, which corresponds to the beginning point in time of that acoustic observation subsequence, is one of only a finite set of possible nodes (shown as three nodes 205 in that figure). In the example of FIG. 2, each separate column of nodes in FIG. 2 corresponds to a 10 millisecond frame of the sequence of acoustic observations as recognized by a speech recognizer, such as by using a frame synchronous beam search technique. The anchor may correspond to one or more nodes, depending on the particular pattern that corresponds to the anchor. Depending upon the type of speech recognition being performed, a node may correspond to a phoneme, a syllable, a word, etc.

By use of the present invention, there is achieved a substantial savings in memory even if the both portions of the speech need to be matched against the same, full network. To be able to do the traceback computation, the speech recognition process would save an array of pointers, or the equivalent thereof. In many applications of interest, this array will typically be the largest component of the memory needed. The size of the array is proportional to the total length of the utterance in frames. In some implementations its size will be the product of the number of frames times the number of nodes in the network. Thus if, for example, the anchor divides the utterance in half, then substantial memory will be saved even if the full network needs to be used for each half

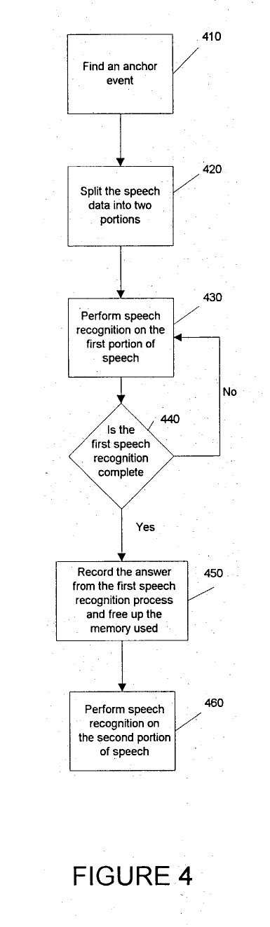

FIG. 4 is a flow chart of the process of sequentially first recognizing the speech portion before the anchor, and then reusing the memory while recognizing the speech portion following the anchor. In particular, block 450 explicitly frees up the memory from the first speech recognition process.

In more detail, in block 410 an anchor event is found. In block 420, the speech data is split into two portions, separated by the anchor. In block 430, speech recognition is performed on the first portion of the speech. In block 440, it is determined if the first speech recognition process is complete. If No, then the process returns to block 430. If Yes, then the process proceed to block 450. In block 450, the results from the first speech recognition process are recorded, and the memory utilized for the first speech recognition process is freed up for use in a second speech recognition to be performed on the second portion of the speech. In block 460, speech recognition is performed on the second portion of the speech.

FIG. 5 is a flow chart of an example embodiment of a computation for matching a hypothesized anchor against a sequence of acoustic observations. It is similar to a dynamic programming computation used to match a word or other speech element against acoustic observations in a conventional speech recognition process, but this embodiment has two main differences. In computing the match for the purpose of spotting an anchor, the present invention according to the embodiment shown in FIG. 5 spots the anchor whenever it occurs and without having recognized the previous speech element. Therefore, block 520 initializes the first node of the network being matched with a start score on every frame, whereas a conventional speech recognition would only initialize the first node of the network when the previous word is ending. There is also an extra block 580 (as compared to a conventional speech recognition) for collecting the score of the last node of the network, if it hasn't been pruned, as the overall match score for spotting the anchor, ending at the current frame.

In more detail, Block 510 activates a loop that goes through each frame of acoustic data.

Block 520 initializes the first node of the network being matched with a start score. This corresponds to allowing the match computation to have the word start at any frame.

Block 530 activates a loop that goes through all of the nodes (or at least all of the nodes with active predecessors) of the network.

Block 540 selects the best path leading to a given current node. For each predecessor node that has an arc leading to the given current node, a partial update score is computed based on the score of the predecessor node at the previous acoustic frame and the probability of transition from the given predecessor node to the given current node. Often the current node will have an arc from the node to itself, so the current node can also be its own predecessor. The current node being its own predecessor corresponds to the event of staying in the node for more than one acoustic frame.

Block 550 updates the partial update score for the given current node based on the acoustic observations for the current frame.

Block 560 tests the score for the current node to see if the node should be pruned, that is made inactive. The loop activated by Block 530 only needs to consider a current node if the current node has a predecessor node that is active. Note that, due to the initialization in Block 520, the first node of the network is always active, which is not necessarily the case in a conventional speech recognition process.

Block 570 completes the loop on the nodes of the given network. Depending upon whether or not the end of the loop of nodes has been reached, the next block to be performed is either Block 530 (when the end of the loop of nodes has not been reached) or Block 580 (when the end of the loop of nodes has been reached).

Block 580 records the score of the final node of the given network, in the circumstance in which a sequence of scores has been passed through a path of nodes leading to that final node without having been pruned. The score represents the accumulated match score for the network from some starting time to the current frame as an ending time. As an additional optional feature, a traceback computation, which is familiar to those skilled in the art of speech recognition, can be used to find the starting time that corresponds to this cumulative score and ending time.

Block 590 completes the loop of acoustic observation frames.

In one embodiment of the present invention, when a sequence of acoustic observations is split up into two separate subsequences of acoustic observations (separated by an anchor), and where speech recognition processing is performed on those two separate subsequences of acoustic observations in sequence, the process continues to look for particular patterns, whereby the two separate subsequences of acoustic observations will be split up based on detection of any of the particular patterns found later on during speech recognition processing of those individual subsequences of acoustic observations. Thus, more than one anchor may be found, and in that case each of the separate acoustic observation subsequences are separately and sequentially processed, and the results concatenated, with the anchors, in order to obtain a speech recognition processing for the entire sequence of acoustic observations.

In a further embodiment of the present invention, the set of anchors (predetermined patterns) can be categorized into a hierarchy of anchors, whereby a search is initially performed for patterns in a top level set of patterns in a pattern hierarchy. If a pattern from this top level set of patterns is found and an anchor set, then for at least one subsequence of acoustic observations a search is performed for a pattern in a second lower level set of patterns that is different from the top level set of patterns. If a pattern is found in this second level of patterns, then an anchor is set. Thus, the event of a top level pattern being found can be used to change the set of patterns being searched for.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass Implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed:

1. A speech recognition method, comprising:
receiving a sequence of acoustic observations;
detecting whether or not at least one of a set of prescribed patterns occurs in the sequence of acoustic observations;
based on the detecting result, setting an anchor for at least one of the set of prescribed patterns detected in the sequence of acoustic observations, and splitting up the sequence of acoustic observations into separate portions separated by the anchor; and
performing a speech recognition processing on each of the separate portions to obtain recognition information, and joining the recognition information along with information of the anchor, to obtain speech recognition processing of an entirety of the sequence of acoustic observations.

2. The method as defined in claim 1, wherein the performing step sequentially performs speech recognition processing on each of the separate portions.

3. The method as defined in claim 1, wherein the anchor is set at a location of the prescribed pattern detected in the sequence of acoustic observations.

4. The method as defined in claim 1, wherein the anchor is set at a location in the sequence of acoustic observations corresponding to an approximate middle position in the sequence of acoustic observations.

5. The method as defined in claim 1, wherein the anchor corresponds to a particular word in the sequence of acoustic observations.

6. The method as defined in claim 1, wherein the anchor corresponds to a particular sequence of phonemes in the sequence of acoustic observations.

7. The method as defined in claim 1, wherein the anchor corresponds to a speech recognized word corresponding to at least one number in the sequence of acoustic observations.

8. The method as defined in claim 1, further comprising:
during the speech recognition processing of each of the separate portions, determining all possible prefix nodes that occur just before occurrence of the anchor in the sequence of acoustic observations, and determining all possible suffix nodes that occur just after occurrence of the anchor in the sequence of acoustic observations.

9. The method as defined in claim 8, wherein the prefix nodes and the suffix nodes are determined based on a particular language model.

10. The method as defined in claim 1, wherein the sequence of acoustic observations corresponds to a sequence of phonemes of a portion of input speech.

11. The method as defined in claim 1, wherein the sequence of acoustic observations corresponds to frequency data of a portion of input speech.

12. The method as defined in claim 1, wherein the sequence of acoustic observations corresponds to a sequence of words of a portion of input speech.

13. A speech recognition system, comprising:
an input unit configured to receive a sequence of acoustic observations;
a pattern detecting unit configured to detect whether or not at least one of a set of predetermined patterns occurs in the sequence of acoustic observations;
an anchor setting unit configured to set an anchor for at least one of the set of prescribed patterns detected, and to split up the sequence of acoustic observations into separate portions separated by the anchor; and
a speech recognition processing unit configured to perform speech recognition processing on each of the separate portions, and to join information obtained from each of the speech recognition processings, along with information of the anchor, to obtain speech recognition processing of an entirety of the sequence of acoustic observations.

14. The system as defined in claim 13, wherein the speech recognition processing unit sequentially performs speech recognition processing on each of the separate portions.

15. The system as defined in claim 13, wherein the anchor is set at a location of the prescribed pattern detected in the sequence of acoustic observations.

16. The system as defined in claim 13, wherein the anchor is set at a location in the sequence of acoustic observations corresponding to an approximate middle position in the sequence of acoustic observations.

17. The system as defined in claim 13, wherein the anchor corresponds to a particular word in the sequence of acoustic observations.

18. The system as defined in claim 13, wherein the anchor corresponds to a particular sequence of phonemes in the sequence of acoustic observations.

19. The system as defined in claim 13, wherein the anchor corresponds to a speech recognized word corresponding to at least one number in the sequence of acoustic observations.

20. The system as defined in claim 13, further comprising:
a node beginning and ending determining unit configured to determine all possible prefix nodes that occur just before occurrence of the anchor in the sequence of acoustic observations, and all possible suffix nodes that occur just after occurrence of the anchor in the sequence of acoustic observations, and to provide that information to the speech recognition processing unit.

21. The system as defined in claim 20, wherein the prefix nodes and the suffix nodes are determined based on a particular language model.

22. A program product having machine-readable program code for performing speech recognition, the program code, when executed, causing a machine to perform the following steps:
detecting whether or not at least one of a set of predetermined patterns occurs in a sequence of acoustic observations;
setting an anchor for at least one of the set of prescribed patterns detected by the first program product code, and splitting up the sequence of acoustic observations into separate subsequences separated by the anchor; and
performing speech recognition processing on each of the separate subsequences, and joining information obtained from each of the speech recognition processings, along with information of the anchor, to obtain speech recognition processing of an entirety of the sequence of acoustic observations.

23. The program product as defined in claim 22, wherein the performing step sequentially performs speech recognition processing on each of the separate portions.

24. The program product as defined in claim 22, wherein the anchor is set at a location of the prescribed pattern detected in the sequence of acoustic observations.

25. The program product as defined in claim 22, wherein the anchor is set at a location in the sequence of acoustic observations corresponding to an approximate middle position in the sequence of acoustic observations.

26. The program product as defined in claim 22, wherein the anchor corresponds to a particular word in the sequence of acoustic observations.

27. The program product as defined in claim 22, wherein the anchor corresponds to a particular sequence of phonemes in the sequence of acoustic observations.

28. The program product as defined in claim 22, wherein the anchor corresponds to a speech recognized word corresponding to at least one number in the sequence of acoustic observations.

29. The program product as defined in claim 22, the program code causing the computing system to further perform the step of:
determining all possible prefix nodes that occur just before occurrence of the anchor in the sequence of acoustic observations, and all possible suffix nodes that occur just after occurrence of the anchor in the sequence of acoustic observations.

30. The program product as defined in claim 22, wherein the detecting step comprises, for each node in a frame synchronous speech recognition process:
taking a score from a best path leading to the node;
updating the score with observations from a current frame;
pruning nodes that are worse that a pruning threshold; and
taking a score of a final node, if not pruned, as a score for spotting the anchor ending at the current frame.

31. The program product as defined in claim 30, further comprising:
using a traceback computation to find a starting time for initiating the detecting step and an ending time for completing the detecting step.

32. The program product as defined in claim 30, wherein the set of predetermined patterns comprises:
a first set of predetermined patterns to be used to initially find anchors in the sequence of acoustic observations; and
a second set of predetermined patterns to be used to find anchors in at least one of the separate subsequences after an anchor has been found from the first set of predetermined patterns.
